(19) United States
(12) Patent Application Publication
(10) Pub. No.: US 2012/0114199 A1
(43) Pub. Date: May 10, 2012

(54) IMAGE AUTO TAGGING METHOD AND APPLICATION

(75) Inventors: Sai Panyam, Sunnyvale, CA (US); Dominic Jason Carr, Agoura Hills, CA (US); Yong Wang, Missouri City, TX (US); Thomas B. Werz, III, Los Angeles, CA (US); Phillip E. Bastanchury, Cypress, CA (US)

(73) Assignee: MYSpace, Inc., Beverly Hills, CA (US)

(21) Appl. No.: 13/290,986

(22) Filed: Nov. 7, 2011

Related U.S. Application Data
(60) Provisional application No. 61/410,716, filed on Nov. 5, 2010.

(51) Int. Cl. G06K 9/00

(52) U.S. Cl. 382/118

(57) ABSTRACT

A method, apparatus, system, article of manufacture, and computer readable storage medium provides the ability to automatically tag a photograph. First photographs are obtained. Each of the first photographs is associated with a tag that uniquely identifies a user. Based on the tag and the first photographs, a single facial identification record (FIR) is generated for the user. A second photograph is uploaded. Profile based FIRs for the user that uploaded the second photograph is obtained. A matching FIR from the profile based FIRs that match a second face in the second photograph is obtained.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/410,716, entitled “IMAGE AUTO TAGGING METHOD AND APPLICATION”, by Sai Panyam, Dominic Jason Can, Allen Wang, Thomas B. Werz III, and Phillip E. Bastanchury, filed on Nov. 5, 2010, Attorney Docket No. 257.4-US-P1.

### BACKGROUND OF THE INVENTION

1. Field of the Invention

The present invention relates generally to computer images, and in particular, to a method, apparatus, and article of manufacture for automatically tagging images with an identity of the person depicted in the image.

2. Description of the Related Art

Digital photographs containing one or more persons are exchanged and uploaded on an increasingly frequent basis. Users often tag or mark a particular photograph (or a face within a photograph) with the identification of the person depicted therein. It is desirable to automatically recognize and tag a person's face with the appropriate identification. However, prior art facial identification and tagging systems are slow, have poor identification and match accuracy, and are manual or only partly automated. Such problems may be better understood with a more detailed explanation of prior art facial identification and tagging systems.

Photographs commonly contain the faces of one or more persons. Users often want to organize their photographs. One method for organizing the photographs is to identify the faces in the photograph and tag or mark the faces and/or the photograph with an identifier of the person depicted. Such tagging may occur in stand-alone applications or on a network. For example, users on social networking sites often upload photographs and tag such photographs with the user's “friends” or the names of users. On social networking sites, millions of photographs may be loaded on a frequent basis.

To tag such photographs, users often manually identify a location in the photograph and then select from a list of all users (e.g., a list of the user's friends is displayed for the user to choose from) to tag that location. In such an instance, the user's software often does not filter nor provide any assistance or facial recognition capabilities. In addition, the user may be required to manually tag each and every photograph independently from other photographs (e.g., manually tagging fifty photographs with the same persons).

Many facial recognition systems that attempt to automatically recognize faces exist in the prior art. However, all of such systems require a control subject. For example, the software may require a photograph of a person in high quality with good lighting, taken at a particular angle, etc. A facial identification record (FIR) (i.e., a unique identification/fingerprint of the person/face) is generated based on the control subject. When a new photograph is uploaded, a new FIR is generated for images in the new photograph and an attempt is made to match the new FIR with the FIR for the control subject. Such matching can be used to determine how close one person is to a new person.

Many problems exist with such prior art facial recognition methodologies. In an online social network, often times, no control subject is available. Instead, users are frequently uploading pictures that aren't taken in a controlled environment and therefore, a comparison to a control based FIR is not possible. In addition, even if a control photograph is available, many factors can affect the accuracy of an FIR generated therefrom. Factors include deviation from a frontal pose that is too large, eyes not open, “extreme” facial expressions, wearing glasses, picture sharpness too low, incomplete face samples or headshot pictures too small, people that look close to their friends, and/or any combination of the above. Alternatively, users may often tag the wrong area of a photograph, tag a photograph that doesn't contain the person's face, tag a photograph of someone they think looks like their friend (e.g., a celebrity), etc.

In addition, when tagging photographs on a social network, as described above, a list of the user's friends is provided for the user to select from. If the person depicted in the photograph is not a “friend” of the user or is not a “member of the social network utilized, the user may be required to manually type in the friend's name.

Accordingly, the prior art provides a very slow process for identifying faces, especially for high volume domains such as social networks (e.g., MySpace™ or Facebook™). In addition, the prior art provides for poor identification and match accuracy, a manual or partly automated process, and requires controlled settings for generating an initial or control FIR.

In view of the above, it is desirable to provide a mechanism to automatically recognize and tag a photograph in an efficient and expeditious manner without requiring a control subject.

### SUMMARY OF THE INVENTION

Embodiments of the invention provide a high through put system for automatically and efficiently generating facial identification records (FIR) from existing photographs that have been manually tagged prior.

The process includes an algorithm to “wash” existing tags and identify tags that can be used to generate a FIR that has a high probability of representing the user for later recognition and verification.

The generated “good” FIRs can then be used to automatically recognize and tag the corresponding person in other photographs.

### BRIEF DESCRIPTION OF THE DRAWINGS

Referring now to the drawings in which like reference numbers represent corresponding parts throughout:

FIG. 1 is an exemplary hardware and software environment 100 used to implement one or more embodiments of the invention;

FIG. 2 schematically illustrates a typical distributed computer system using a network to connect client computers to server computers in accordance with one or more embodiments of the invention;

FIG. 3 is a flow chart illustrating the logical flow for automatically tagging a photograph in accordance with one or more embodiments of the invention;

FIG. 4 is a screen shot illustrating a tool application that may be used to verify an auto tagging result in accordance with one or more embodiments of the invention;

FIG. 5 is an algorithm for generating the best FIR in accordance with one or more embodiments of the invention;

FIG. 6 illustrates an exemplary database diagram used for the FIR storage in accordance with one or more embodiments of the invention;

FIG. 7 is a workflow diagram for optimizing the processing in accordance with one or more embodiments of the invention;

FIG. 8 is diagram illustrating work distribution in accordance with one or more embodiments of the invention;

FIGS. 9A-9C are flow charts illustrating the tag approval process in accordance with one or more embodiments of the invention; and

FIG. 10 is a flow chart illustrating the image auto tagging enrollment process based on the tag approval process in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

To overcome the problems of the prior art, photographs that have already been tagged are analyzed. Based on the analysis, an FIR is generated to represent a tagged user. The FIR can then be used to automatically recognize and tag the corresponding person in other photographs.

### Hardware Environment

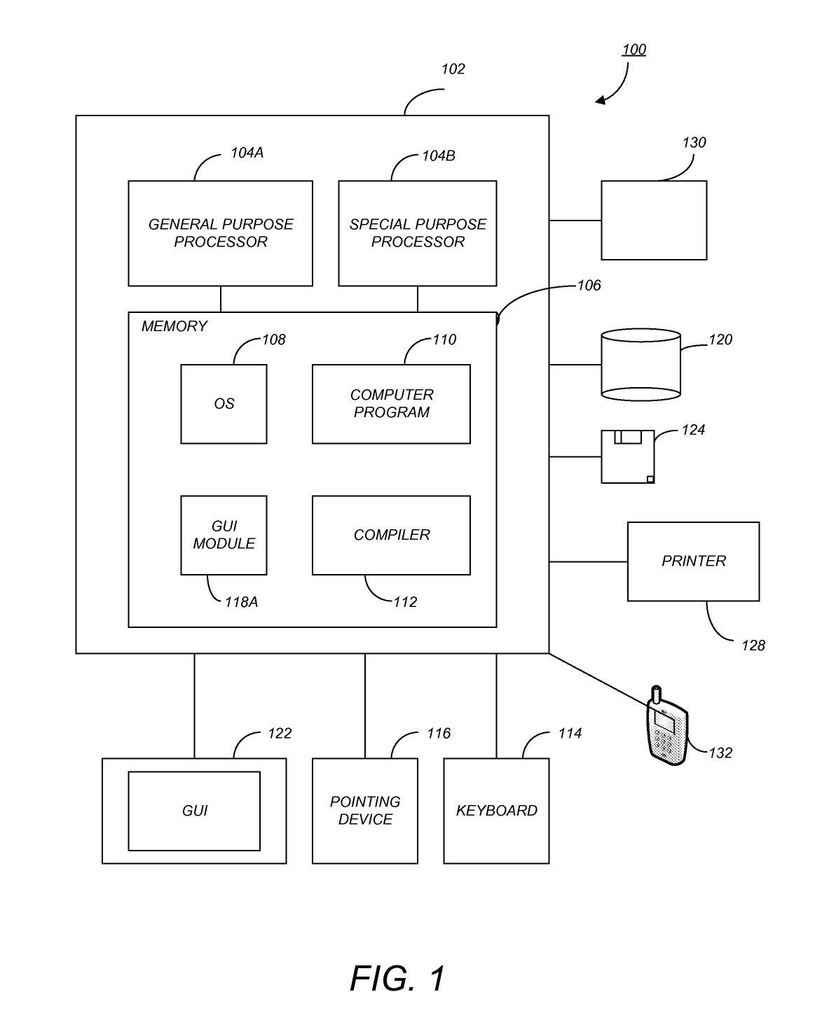

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 (also referred to herein as user 102) comprises a general purpose hardware processor 104A and/or a special purpose hardware processor 104B (hereinafter alternatively collectively referred to as processor 104) and a memory 106, such as random access memory (RAM). The computer 102 may be coupled to other devices, including input/output (I/O) devices such as a keyboard 114, a cursor control device 116 (e.g., a mouse, a pointing device, pen and tablet, etc.) and a printer 128. In one or more embodiments, computer 102 may be coupled to a portable/mobile device 132 (e.g., an MP3 player, iPod™, Nook™, portable digital video player, cellular device, personal digital assistant, etc.).

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Each liquid crystal of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

As used herein, the computer 102 may be utilized within a .NET™ framework available from Microsoft™. The .NET framework is a software framework (e.g., computer program 110) that can be installed on computers 102 running Microsoft™ Windows™ operating systems 108. It includes a large library of coded solutions to common programming problems and a virtual machine that manages the execution of programs 110 written specifically for the framework. The .NET framework can support multiple programming languages in a manner that allows language interoperability.

The computer 102 may also implement a compiler 112 which allows an application program 110 written in a programming language such as COBOL, Pascal, C++, FORTRAN, or other language to be translated into processor 104 readable code. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

Although the term “user computer” or “client computer” is referred to herein, it is understood that a user computer 102 may include portable devices such as cell phones, notebook computers, pocket computers, or any other device with suitable processing, communication, and input/output capability.

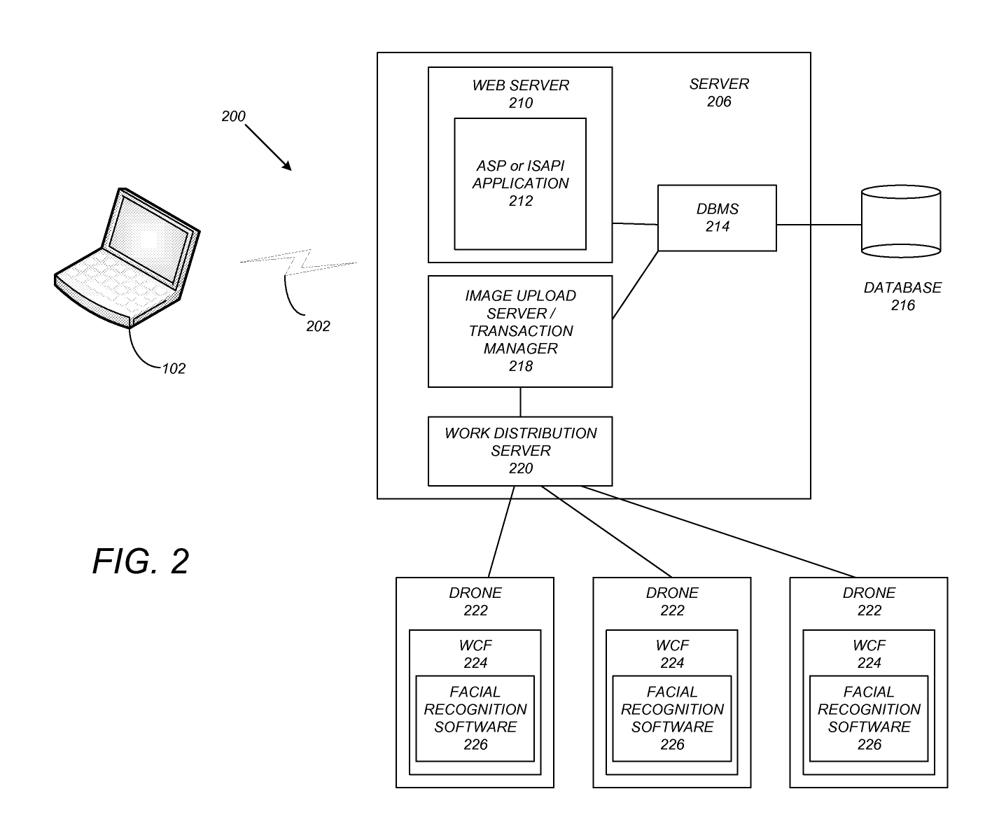

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1).

A network 202 such as the Internet connects clients 102 to server computers 206. Network 202 may utilize Ethernet, coaxial cable, wireless communications, radio frequency (RF), etc. to connect and provide the communication between clients 102 and servers 206. Clients 102 may execute a client application or web browser and communicate with server computers 206 executing web servers 210 and/or image upload server/transaction manager 218. Such a web browser is typically a program such as MICROSOFT INTERNET EXPLORER™, MOZILLA FIREFOX™, OPERA™, APPLE SAFARI™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of or connected directly to client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

The image upload sever/transaction manager 218 communicates with client 102 and the work distribution server 220. In turn, the work distribution server 220 controls the workload distribution of drones 222. Each drone 222 includes facial recognition software 226 that is wrapped in a windows communication foundation (WCF) application programming interface (API). The WCF is a part of the Microsoft™ .NET™ framework that provides a unified programming model for rapidly building service-oriented applications that communicate across the web. Accordingly, any type of facial recognition software 226 may be used as it is wrapped in a WCF API 224 to provide an easy and efficient mechanism for communicating with work distribution server 220. The drones 222 are used to perform the various facial recognition techniques (e.g., recognizing faces in an image and generating FIRs) and multiple drones 222 are used to provide increased throughput. Drones 222 may be part of server 206 or may be separate computers e.g., a drone recognition server. Details regarding the actions of image upload server/transaction manager 218, work distribution server 220, and drone 222 are described below.

Generally, these components 208-226 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include portable devices such as cell phones, notebook computers, pocket computers, or any other device with suitable processing, communication, and input/output capability.

Of course, those skilled in the art will recognize that any combination of the above components, or any number of different components, peripherals, and other devices, may be used with computers 102 and 206.

### Software Embodiments

Embodiments of the invention are implemented as a software application 110 on a client 102, server computer 206, or drone 222. In a stand-alone application, embodiments of the invention may be implemented as a software application 110 on the client computer 102. However, in a network (e.g., an online social networking website such as MySpace™ or Facebook™), the software application 110 may operate on a server computer 206, drone computer 222, on a combination of client 102-server 206-drone 222, or with different elements executing on one or more of client 102, server 206, and/or drone 222.

The software application 110 provides an automatic tagging mechanism. Goals of the automatic tagging include helping users locate their friends on their photographs, gathering information about photograph content for monetization, and providing alternate features such as finding someone that looks like a user or finding celebrities that look that a user.

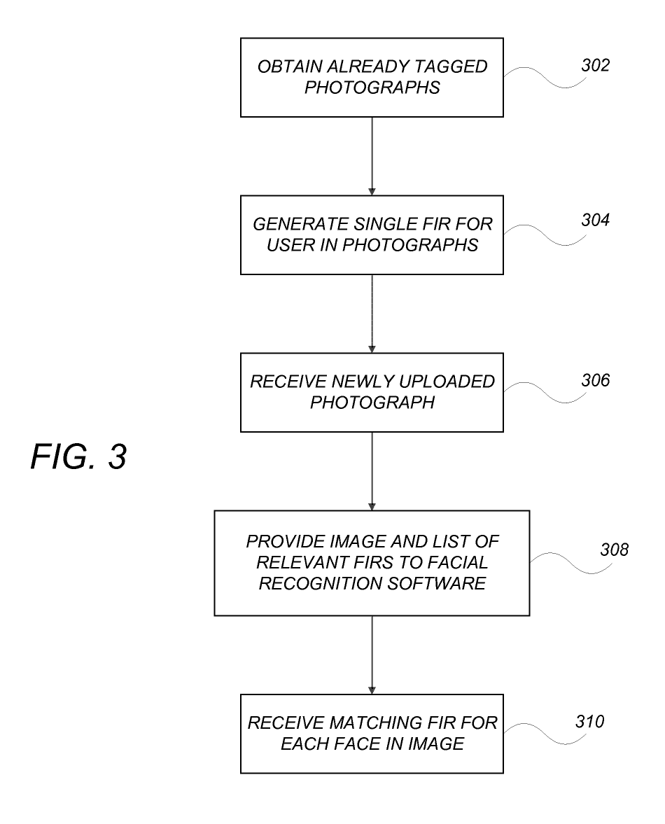

FIG. 3 is a flow chart illustrating the logical flow for automatically tagging a photograph in accordance with one or more embodiments of the invention. At step 302, images/photographs that have already been tagged (manually or otherwise) by a user are obtained/received.

At step 304, a single FIR is generated for a user depicted in the photographs. The single FIR assigned to a user (if the user has authorized/signed up for automatic tagging) may be cached using a reverse index lookup to identify a user from the FIR.

At step 306, a newly uploaded photograph is received (i.e., in an online social network) from a user.

At step 308, the social network retrieves a list of FIRs for the user and the user's friends (alternative methods for finding relevant FIRs that have some relationship to the user [e.g., friends of friends, online search tools, etc.] may be used). This list of relevant FIRs is provided to facial recognition software. The facial recognition software performs various steps to match each face found in the image to one of the provided FIRs. If a tag received from a user (e.g., a user manually tags the photo) cannot be found from the list of relevant FIRs, a notification may be sent to the photograph owner who then could identify the face. That identification could be used to create a new FIR/fingerprint for the identified friend. Accordingly, there may be a feedback loop process by which a photograph owner's manual identification is used to grow the FIR store. In addition, if a user approves a photograph tag, such a process may be used to validate automatic tags. Once an automatically tagged photo has been validated, the tag's metadata may be used to further refine the FIR/fingerprint metadata for the user.

At step 310, the online social network receives (from the facial recognition software) the matching FIR for each face in the image/photograph that was provided. The matching FIR may also be accompanied (from the facial recognition software) by a match score indicating the likelihood that the provided FIR matches the face in the image. As described above, various properties may impact the match score and/or likelihood of finding a match to a face in a given photograph.

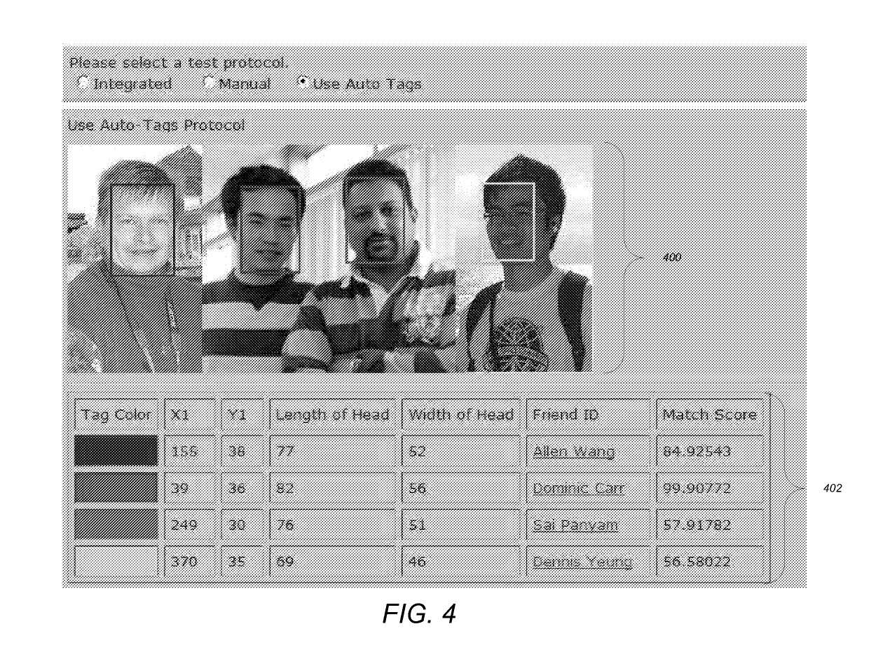

Accordingly, using the steps of FIG. 3, faces in images/photographs may be automatically identified and tagged based on the user's prior identification (e.g., by selecting identifications based on the user and the user's friends). Once tagged, it may be useful to confirm/reject the suggested tags/identifications. FIG. 4 is a screen shot illustrating a tool application that may be used to verify an auto tagging result in accordance with one or more embodiments of the invention.

The photograph(s) 400 may be displayed with a table 402 containing relevant fields/attributes. As shown, different tags (i.e., boxes surrounding each identified face in photograph 400) can be used for each face. Different tag colors (e.g., red, blue, green, yellow, etc.) can be used to differentiate the tags in the image 400 itself (and their corresponding entries in the table 402). Additional fields/attributes in table 402 may include the coordinates (X1,Y1) of the center (or origin) of each tag in photograph 400, the length and width of the head, a textual identification/name of the person identified, and the match score indicating the probability that the identified person (i.e., the corresponding FIR) matches the tagged face. Accordingly, users may have the option of viewing the tool of FIG. 4 to confirm the identification of faces in a photograph.

The following table illustrates an XML sample for storing image auto tags generated from a batch of photo uploads for a single federation in accordance with one or more embodiments of the invention.

<Recognition>
<Images>

| | |
|---|---|
| <!-- | XML Sample for storage Image Auto Tags generated |

from a batch of photo uploads for a single federation. -->
<Image ImageId=“44066027” UserId=“3047371”>

<Faces Count=“4”>

<!-- We'd like to quickly know how many faces were
found -->

<Face FaceId=“1”>

<!-- The tag is defined by a rectangle compatible with

manual tagging -->

<Rectangle X1=“203” Y1=“62” X2=“303”
Y2=“162” />
<Match>

<FriendId>23077568<FriendId>
<Note />
<!-- Used when not a friend; -->
<MatchScore>99.90</MatchScore>
<!-- 0.00 .. 100.00 : empty => 0.00 -->

</Match>
<FaceAttributes>

<Ethnicity>White</Ethnicity>
<!-- enum: White, Black, Asian -->
<Sex>Male</Sex>
<!-- enum: Male, Female -->
<Age>Child</Age>
<!-- enum: Child, Adult -->
<Other>Glasses</Other>
<!-- enum: Glasses, None -->

<FaceAttributes>

</Face>
<Face FaceId=“2”>

<Rectangle X1=“53” Y1=“46” X2=“153”
Y2=“146” />
<Match />
<!-- No match -->
<FaceAttributes>

<Ethnicity>Asian</Ethnicity>
<Sex>Female</Sex>
<Age>Adult</Age>
<Other>None</Other>

</FaceAttributes>

</Face>
<Face FaceId=“3”>

<Rectangle X1=“257” Y1=“174” X2=“357”
Y2=“274” />
<Match>

<FriendId>21673587</FriendId>
<Note />
<MatchScore>45.00</MatchScore>

</Match>
<FaceAttributes>

<Ethnicity>Asian</Ethnicity>
<Sex>Male</Sex>
<Age>Child</Age>
<Other>Glasses</Other>

</FaceAttributes>

</Face>
</Face FaceId=“4”>

<Rectangle X1=“434” Y1=“91” X2=“534”
Y2=“191” />
<Match>

<FriendId>104761857</FriendId>
<Note />
<MatchScore>100.00</MatchScore>

</Match>
<FaceAttributes>

<Ethnicity>Black</Ethnicity>
<Sex>Female</Sex>
<Age>Adult</Age>
<Other>None</Other>

</FaceAttributes>

</Face>
</Faces>

</Image>
<Image>

<! -- As above -->

<Image>
</Images>
</Recognition>

Based on the above results, the following table is an XML sample for the storage of demographics generated from a batch of photograph uploads in accordance with one or more embodiments of the invention.

<Demographics>
<Images>
<Image ImageId=″44066027″ UserId=″3047371″>

<!-- The FoundFaceMetaData node should be stored in an XML field.

The contents are currently subject to change but represent
the attributes we currently can glean from a photo. -->

<FoundFaceMetaData>

<Ethnicity Whites=″1″ Blacks=″2″ Asians-″1″ />
<Sex Males=″1″ Females=″3″ />
<Age Adults=″2″ Children=″2″ />
<Accessories WearingGlasses=″1″ />
<!-- To support very specific search conditions we enumerate
the details for each face. -->
<Faces Count=″4″>

<Face FaceId-“1”>

<FaceAttributes>

<Ethnicity>White</Ethnicity>
<!-- enum: White, Black, Asian -->
<Sex>Male</Sex>
<!-- enum: Male, Female -->
<Age>Child</Age>
<!-- enum: Child, Adult -->
<Other>Glasses</Other>
<!-- enum: Glasses, None -->

<FaceAttributes>

</Face>
<Face FaceId=″2″>

<FaceAttributes>

<Ethnicity>Asian</Ethnicity>
<Sex>Female</Sex>
<Age>Adult</Age>
<Other>None</Other>

</FaceAttributes>

</Face>
<Face FaceId=″3″>

<FaceAttributes>

<Ethnicity>Asian</Ethnicity>
<Sex>Male</Sex>
<Age>Child</Age>
<Other>Glasses</Other>

</FaceAttributes>

</Face>
</Face FaceId=″4″>

<FaceAttributes>

<Ethnicity>Black</Ethnicity>
<Sex>Female</Sex>
<Age>Adult</Age>
<Other>None</Other>

</FaceAttributes>

</Face>

</Faces>

</FoundFaceMetaData>
</Image>
<Image>

<! -- As above -->

<Image>
</Images>
</Demographics>

Facial Identification Record Generation

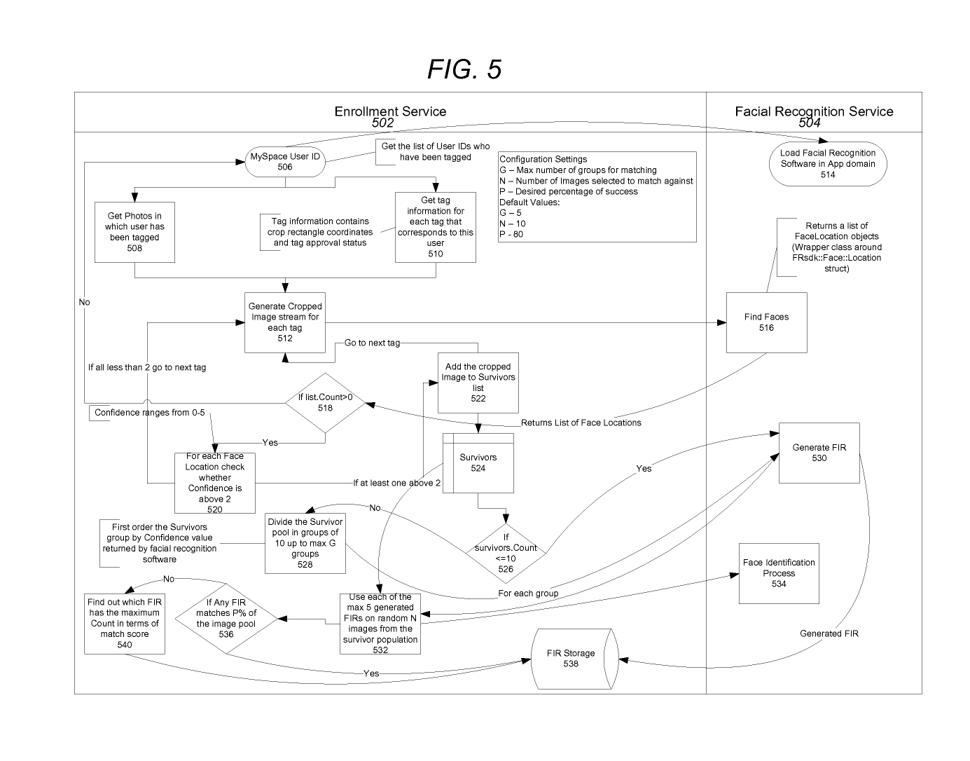

Returning to FIG. 3, each of the steps 302-310 may be utilized to automatically (i.e., without any additional user input) identify and tag faces with likely FIRs. As described above, step 304 is used to generate a single FIR for a user—i.e., an FIR to be used as a control is generated. FIG. 5 is an algorithm for generating the best FIR in accordance with one or more embodiments of the invention.

In FIG. 5, there are two different services that are performing the relevant actions—the enrollment service 502 and the facial recognition service 504. The enrollment service 502 may be part of the image upload server 218 while the facial recognition software is wrapped in the WCF 224 and may be implemented in various drones 222. The facial recognition service/software 504 may be FaceVACS™ available from Cognitec Systems™ or may be different facial recognition software available from a different entity (e.g., the Polar Rose™ company). Any facial recognition service/software may be used in accordance with embodiments of the invention. Further, the enrollment service 502 may accept input from an image database (e.g., uploaded by the user) and utilizes binary information provided in the tags to perform the desired processing.

At 506, a user identification is retrieved. Such a step may further retrieve the list of user IDs who have been tagged.

At step 508, the photographs in which the user (of step 506) has been tagged are obtained (e.g., a photograph ID). Similarly, at step 510, tag information for each tag that corresponds to the user is obtained. Such tag information may contain crop rectangle coordinates and tag approval status (e.g., when a user has been tagged by a friend, the user may need to “approve” the tag). The crop rectangle coordinates represent the location in the photograph (obtained in step 508) of coordinates (x1,y1), (x2,y2), etc. for each tag. Multiple tags for each photograph are possible.

At step 512, for each tag, a cropped image stream is generated.

While step 506-512 are performed, various actions may be performed by the facial recognition service 504. At step 514, the facial recognition software is loaded in the application domain.

Once the cropped stream is generated at step 512, the facial recognition service 504 (e.g., via the facial recognition software application loaded at 514) is used to find faces in the photographs at step 516. Such a step locates the faces in the cropped image stream provided by the enrollment service 502 and returns a list of face location objects. The facial recognition software may have a wrapper class around the location structure. The list of face locations is then returned to the enrollment service 502.

A determination is made at 518 regarding whether the list of face locations is empty or not. If no faces have been found in the cropped images, the process returns to step 506. However, if any faces have been found, at step 520, for each face location, a check is made regarding whether the confidence (regarding whether a face has been found) is above a threshold level (e.g., two [2]). Thus, even if faces have been found, the facial recognition software 504 provides a confidence level (ranging from 0 to 5) regarding whether or not the face is actually a face. If all of the confidences are less than two (2) (i.e., below a given threshold), the process returns to step 512. However, if the facial recognition software 504 is confident that a face has been found, at step 522 the cropped image is added to a “survivor list” 524. The survivor list includes cropped images that are likely to contain a face.

The next step in the process is to actually generate an FIR for each face. As more information/images/faces are used to generate an FIR, the data size of the FIR increases. Further, it has been found that if more than ten (10) faces are used to generate an FIR, the FIR data size becomes too large and the results do not provide a significantly more accurate FIR than those FIRs based on ten (10) or less faces (i.e., there are diminishing returns). Accordingly, embodiments of the invention work in groups of ten faces to calculate an FIR that represents those faces. At step 526, a determination is made regarding whether there are more than ten (10) cropped images in the survivor list.

If there are more than ten cropped images in the survivor list, the survivor pools is divided into groups of ten (up to a maximum number of G groups) at step 528. Before dividing the pool, the survivors may be ordered by the confidence value that a face has been found. Such a confidence level identifies a level of confidence that a face has been found and may include percentages/consideration of factors that may affect the face (e.g., the yaw, pitch, and/or roll of the image).

If there are less than ten (10) cropped images in the survivor list and/or once the pool has been divided into groups of ten or less, an FIR is generated for each group at step 530 (e.g., by the facial recognition service 504). As a result, multiple FIRs may be generated.

At step 532, a maximum of five (5) generated FIRs are selected and used. In step 532, the five FIRs are used against a number N of selected images that have been selected to match the FIR against. For example, suppose there were 100 images that were each tagged with a particular user. Cropped images were generated at step 512 and suppose faces were found in each cropped image with a confidence level all above 2 at step 516. The resulting cropped images are broken up into ten groups of ten (at step 528) and an FIR is generated for each group at step 530. The result from step 530 is ten FIRs that all represent the particular user that was tagged. Five of the FIRs are then selected at step 532 to use against N of the original images/photos (obtained at step 508). Such FIRs may all be stored in the FIR storage 538. Alternatively, the FIRs may not be stored at this time but used in steps 532-540 before being stored.

At step 534, a face identification process is performed by the facial recognition service 504 to locate the faces in the original images and compare the five (5) or less FIRs to the N images. The facial recognition service 504 provides a match score as a result that scores the match of the FIR against the face in the image. A determination is made at step 536 regarding whether any of the match scores for any of the FIRs (generated at step 530) meet a desired percentage (P %—the desired percentage of success) of the image pool. If any one of the FIRs meets the success threshold percentage desired, it is added to FIR storage 538. However, if no FIR meets the desired success threshold, the FIR that has the maximum count in terms of the match score (against the N images selected) is selected at step 540 and added to FIR storage 538. Thus, continuing with the example above, the five (5) selected FIRs are then compared against N images to find the FIR that has the highest match score for the tagged user. The highest matching FIR is then selected as the FIR that represents the tagged user and is stored in file storage 538.

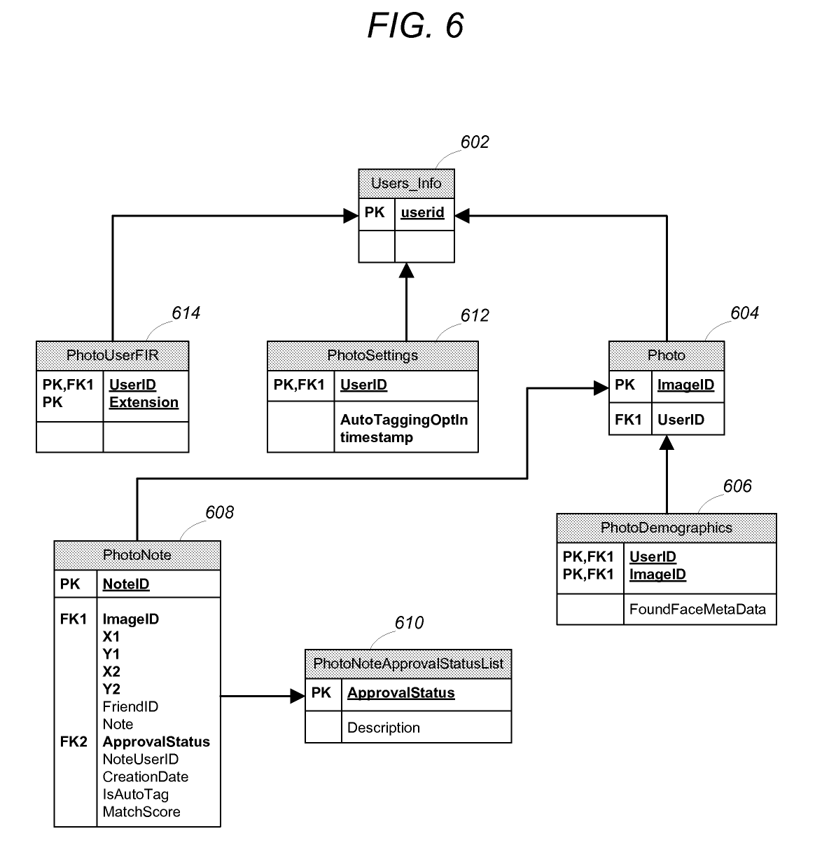

FIG. 6 illustrates an exemplary database diagram used for the FIR storage 538 in accordance with one or more embodiments of the invention. A primary key for the user ID is stored for each user in a user info table 602. For each photo (i.e., in photo table 604, an image ID is stored as the primary key and a foreign key identifies a user in the photo. A photo demographics table 606 references the photo table 604 and provides metadata for faces found in the photo 604. A photo note table 608 further references the photo table 604 and provides identification of tags for each photo 604 including a location of the tags (e.g., (x1,y1), (x2,y2) coordinates), an ID of the friend that has been tagged, and the approval status indicating whether the tag has been approved or not by the friend. A photo note approval status list table 610 further contains primary keys indicating the approval status and descriptions of tags that have been approved.

In addition to tables 602-610, a photo settings table 612 references the user table 602 and provides information regarding whether the automatic tagging option is on or off. Further, the photo user FIR table 614 contains a listing of the FIR corresponding to each user.

Optimization of Facial Recognition Service

The enrollment service 502 of FIG. 5 may be optimized to provide more efficient and faster processing. Benchmark testing can be performed to determine how and what areas of the enrollment service should be adjusted for optimization. Such benchmark testing may include using different processor and/or operating systems to conduct various jobs including the processing of multiple numbers of faces. Such jobs may attempt to process/find faces in photographs while recording the time used for processing, faults, time per image, and the CPU percentage utilized. Results of the benchmark testing may further map/chart the image rate against affinity, an increase in speed using certain processors, and the throughput of two server farm configurations against affinity. Based on the benchmark testing, a determination can be made regarding whether to use certain numbers of high specification machines versus an increased number of lower specification machines, how much memory is used, etc. For example, in one or more embodiments, conclusions from benchmark testing may provide the following:
Memory plays a role when processing low volumes but the affect of memory decreases as affinity usage/workload increases;
Fifty (50) machines with higher specifications would still be outperformed by seventy-five (75) machines with lower specifications; and
Approximately sixty-six (66) high specification machines are needed to perform the work of seventy-five (75) lower specification machines.

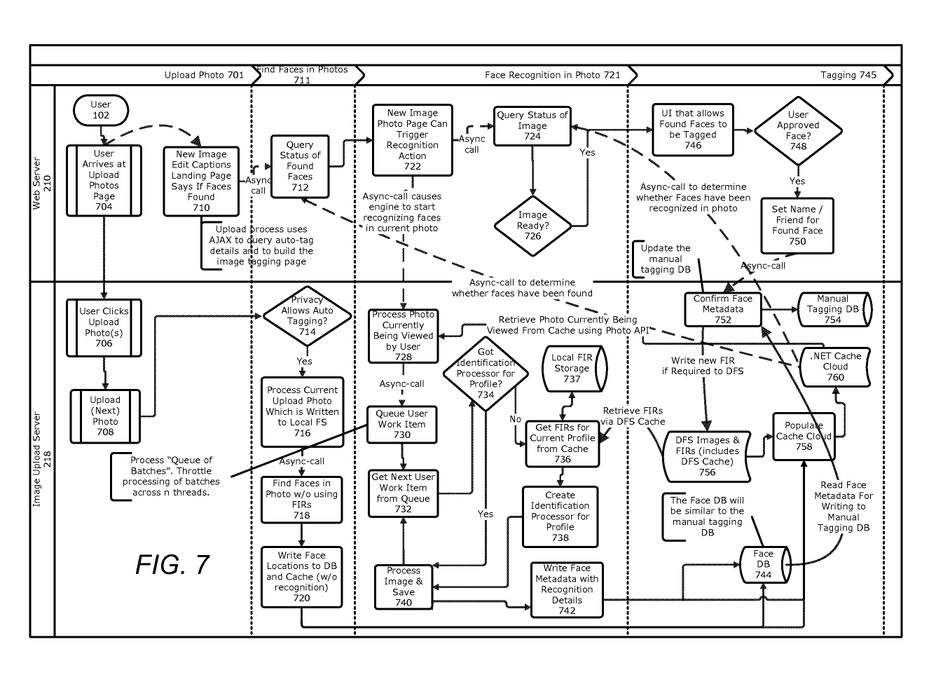

Based on the benchmark testing, various optimizations may be conducted. FIG. 7 is a workflow diagram for optimizing the processing in accordance with one or more embodiments of the invention. The upper part of the diagram illustrates the actions performed by the web server 210 while the lower part of the diagram illustrates the image upload server 218 workflow.

During the photo upload process 701, a user 102 accesses the web server 210 and arrives at the upload photos page 704. The user 102 then proceeds to upload photos using the image upload server 218 (at 706 and 708). In addition, the upload process may use AJAX (asynchronous JavaScript™ and XML [extensible markup language]) web development methods to query automatic tagging details and to build the image tagging page thereby resulting in a new image edit captions landing page that indicates whether faces have been found 710.

The next stage in the workflow is to find faces in the photographs at 711. In the web server 210, an asynchronous call is conducted to query the status of found faces at 712. In the image upload server 218, a determination is made regarding whether the user's privacy settings allow automatic tagging at 714. If automatic tagging is allowed, the current uploaded photo is processed and written to local file storage 716. An asynchronous call is made to find faces in the photograph without using FIRs 718. The face locations are then written to the database and cache (without the facial recognition or FIRs assigned to the faces) 720.

After finding faces in the photographs, the process attempts to recognize the faces in the photographs 721. In the web server 210, a new image photo page can trigger the initiation of the recognition action 722. The recognition action will conduct an asynchronous call to query the status of the image 724 which is followed by a determination of whether the image is ready or not 726. The recognition action further asynchronously causes the image upload server 218 (also referred to as an image upload engine) to begin recognizing faces in the photos.

The photo currently being viewed by the user is processed 728. In addition, a “queue of batches” may be processed where the processing of batches of photographs across “n” threads are controlled/throttled (e.g., via a work distribution server) by queuing one or more user work items 730 (e.g., for various drones). A work item is retrieved from the queue 732 and a determination is made regarding whether an identification processor for the profile is available 734. If no profile is available, FIRs for the current profile are retrieved 736 from cache (or local FIR storage 737), an identification processor for the profile is created 738, and the image is processed and saved 740.

Similarly, if a profile has already been created the image is merely processed and saved 740. The following table illustrates a sample that can be used by an enrollment process to write location details for profile FIRs in accordance with one or more embodiments of the invention.

<Enrollment>
<Profiles>

<Profile ID=”1234567” DFSPath=”dfs://blah/blah”>

<FIRS>

<!-- We may have up to 11 FIR elements -->
<FIR>

<Action>Insert</Action>
<!-- Insert, Update, Delete -->
<Extension>FIR001</Extension>

</FIR>

</FIRS>

</Profile>
<Profile ID=”7654321” DFSPath=”dfs://blah/blah”>

<FIRS>

<FIR>

<Action>Insert</Action>
<Extension>FIR001</Extension>

</FIR>
<FIR>

<Action>Insert</Action>
<Extension>FIR002</Extension>

</FIR>

</FIRS>

</Profile>

</Profiles>
</Enrollment>

After processing and saving the image 740, the next user work item is retrieved 732 and the process repeats. Further, face metadata with recognition details are written/created and stored 742 in the face database 744 (which is similar to a manual tagging database). The face database 744 is also used to store the face locations from the “find faces” stage.

The next stage in the process is the tagging 745. In the web server 210, if the image is ready (as determined at 726), the user interface that allows found faces to be tagged is provided to the user at 746. Once the user approves the face 748, the name/friend for a found face is established/saved/set 750. Once established, the face metadata is confirmed 752 in the image upload server 218 which may update the manual tagging database 754. The confirming process 752 may retrieve the face metadata from the face database 744. Also, the confirmation process 752 may write new FIR, if required, to data file storage. Images and FIRs 756 stored in DFS (which includes DFS cache and FIRs retrieved from DFS cache) may also be used to populate the cache cloud 758 (and in turn, the .NET cache cloud 760). The .NET cache cloud 760 retrieves the photos currently being viewed from cache using an application programming interface (for processing at 728) while also making asynchronous calls to: (1) determine whether faces have been found (i.e., via the web server 210 in the find faces stage via 712); and (2) determine whether faces have been recognized in the photo (i.e., via the web server 210 in the face recognition stage via 724).

Automatic-Image Tagging Work Distribution

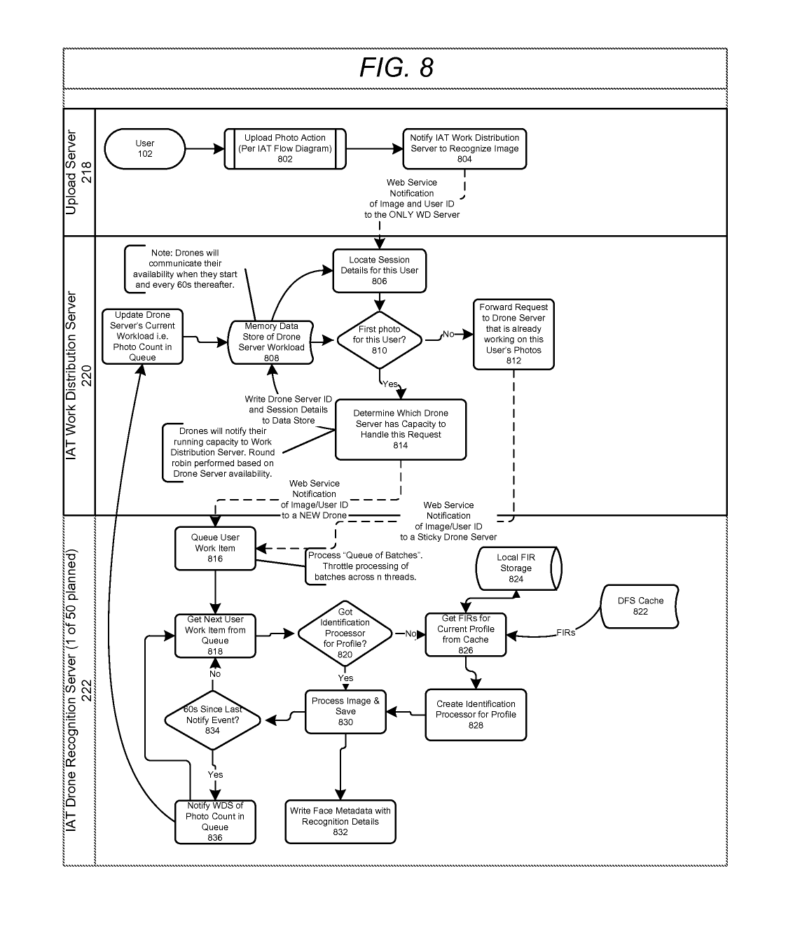

As described above, a work distribution server (WDS) 220 may be used to distribute various jobs to drones 222 that contain or communicate with WCF 224 wrapped facial recognition software 226. FIG. 8 is diagram illustrating work distribution in accordance with one or more embodiments of the invention. In general, drones 222 notify the WDS 220 of availability while the WDS 220 manages the workload amongst the various drones 222 (e.g., by sending individual messages to each drone in batches to have the work performed). The drone 222 works with the facial recognition software 226 to load the various FIRs (i.e., the FIRs of the user and the user's friends), and to process and recognize the faces in the images. The drone 222 sends a message back to the WDS 220 when it is done with the processing.

The upload image server 218 provides the ability for a user 102 to perform an upload photo action 802 (per FIG. 7) and notify the work distribution server 220 to recognize the image at 804. In response, the web service notification of the image and user ID is forwarded to the single work distribution server 220.

The work distribution server 220 locates session details for the user 102 at 806. Session details may include various details regarding drones 222 that have been assigned to process the photo. Accordingly, the drone server's 222 current workload (e.g., photo count in a queue) may be loaded into a memory data store 808. The drone's 222 workload may be updated via the drone's 222 availability status which is communicated once a drone 222 commences work and every sixty (60) seconds thereafter. A determination is made regarding whether the photo is the first photo being processed for the user 102 at 810. If it is not the first photo, the request is forwarded to the drone server 222 that is already working on this user's photos at 812. Such forwarding may include a web service notification of the image/user ID to the drone server 222.

If the photo is the first photo for the user being processed, a determination is made regarding which drone server 222 has the capacity to handle the request at 814. Data needed to determine drone server 222 capacity may be obtained from the memory data store 808 containing each drone server's 222 workload. Further, such a determination may update the memory data store 808 with the drone server 222 ID and session details. Drones 222 may notify the work distribution server 220 of the drone's 222 running capacity. Based on server availability, round robin processing may be performed (and managed by the work distribution server 222).

Once a particular drone server 222 with the capacity has been identified, the web service notification of the image/user ID is forwarded to the new drone 222. Upon receiving a web service notification from the work distribution server 222, the drone 222 queues the user work item at 816. A queue of batches may be processed such that batches of processes are performed across numerous “n” threads that may be throttled depending on availability/capacity.

To begin processing a work item, the drone 222 retrieves the next work item from the queue at 818. A determination is then made regarding whether an identification processor for the profile is available at 820. In this regard, an identification processor is a class for each profile that may be used to identify user IDs for the user and friends of the user. If the identification processor is not available, FIRs for the current profile are retrieved from cache 822 and local file storage 824 (i.e., at 826) and an identification processor for the profile is created at 828. Once an identification processor for the user's profile is loaded in the drone 222, the image can be processed and saved at 830. Once processed, the face metadata with recognition details is written in the database at 832.

A timer is expected to fire every sixty (60) seconds. If the work distribution server 220 does not receive a timer firing within two (2) minutes, it will presume the drone 222 is out of commission. Accordingly, a drone 222 must fire the timer event when is starts so that the work distribution server 220 knows which drones 222 are available. Thus, once the image has been processed and saved at 830, the drone server 222 determines if it has been more than sixty (60) seconds since the last timer event firing at 834. If not, the next user work item from the queue is retrieved at 818 and the process repeats. If it has been more than sixty (60) seconds, the work distribution server 220 is notified of the photo count in the queue at 836.

Image Tag Approval Processing and Use

Image Tag Approval Process

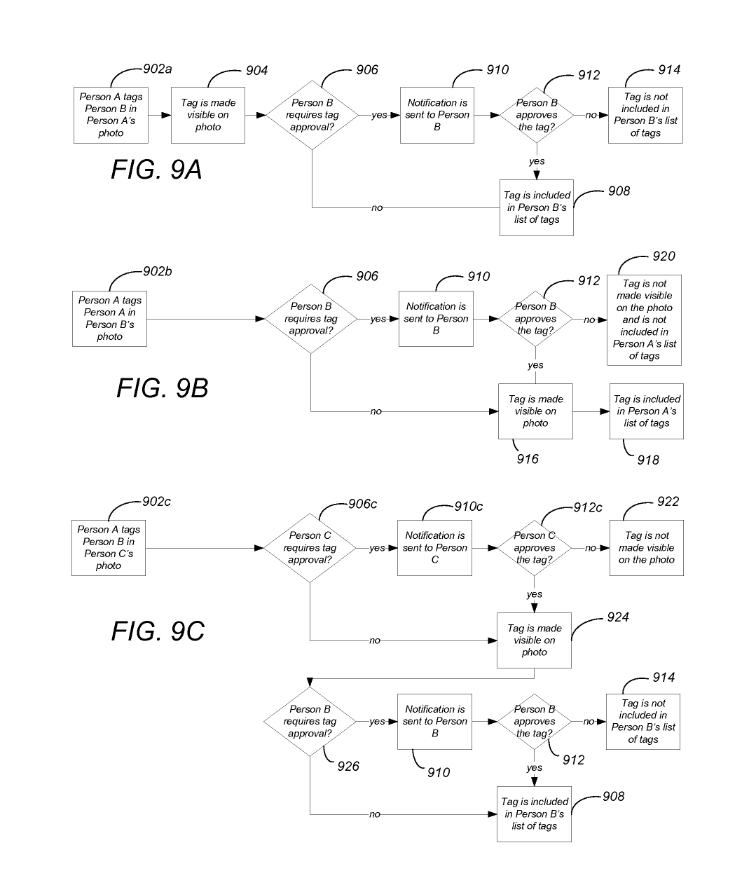

Step 508 of FIG. 5 provides for obtaining/getting photographs in which the user has been tagged. The tagging process of a photograph may proceed through a tag approval status in which table 610 described above is updated. FIGS. 9A-9C are flow charts illustrating the tag approval process in accordance with one or more embodiments of the invention.

There are three use cases for the tag approval process:

In the first use case referred to as “ABA tagging,” (reflected in FIG. 9A), person A tags person B in person A's photo at step 902a. In this case, at step 904, the tag is immediately visible on the photo because the owner created the tag (this is considered an implicit approval).

A determination is made at step 906 regarding whether person B requires tag approval of the tags or not. If approval is not required, the tag is included in person B's list of tags at step 908. If approval is required, the friend is notified of the tag at step 910 and is presented with an option to accept or reject that the face is them at step 912.

If person B accepts the tag, the tag is included in their list of approved face tags at step 908. These tags are added to the users list of approved tagged faces. If person B denies the tag, the tag still exists on the photo, but it is not added to person B's list of approved face tags at step 914.

In the second use case illustrated in FIG. 9B, referred to as “AAB Tagging,” person A tags person A in person B's photograph at step 902b. In this case, the owner of the photo must first approve the face tag before it will be visible to anyone and before it will be used in the image auto tagging described above. If the owner of the photo (i.e., person B) accepts the tag at step 912, it is made visible on the photo at step 916. Further, it is made available to the image auto tagging application by adding it to person A's list of approved face tags at step 918. However, if person B does not approve the tag at step 912, the tag is not made visible on the photo and is not included in person A's list of tags at step 920.

The third use case is illustrated in FIG. 9C and is referred to as “ABC tagging:” Person A tags person B in person C's photo. In this case, the owner of the photo (Person C) must first approve the tag before it will be visible to anyone and before it will be used in the image auto tagging (i.e., approval is required at step 906c). If the owner of the photo does not accept the tag, the tag is not made visible on the photo at step 922. However, if approved, the tag is made visible on the photo at step 924.

The process then proceeds to step 926 to determine if approval of the tag is also required from person B. If approval of person B is required, the process proceeds as described with respect to steps 908-914 of FIG. 9A

The tag approval process ensures that quality images are used in the image auto tagging system, thus improving the quality of the FIR's and improving its accuracy. In this regard, embodiments of the invention may enhance the quality of an FIR by obtaining approval of the person whose face was tagged, through manual or automated methods using various methods. A first method requires the person whose face was tagged to manually approve the tag. A second method automatically approves the face tag. The third method requires the person who owns the photograph to implicitly or explicitly approve the creation of the face tag in their photo. Alternatively, the quality of the FIR may be enhanced by implicitly or explicitly requiring some form of approval of a face tag prior to using it for FIR generation.

Image Auto Tagging Enrollment Based on Tag Approval

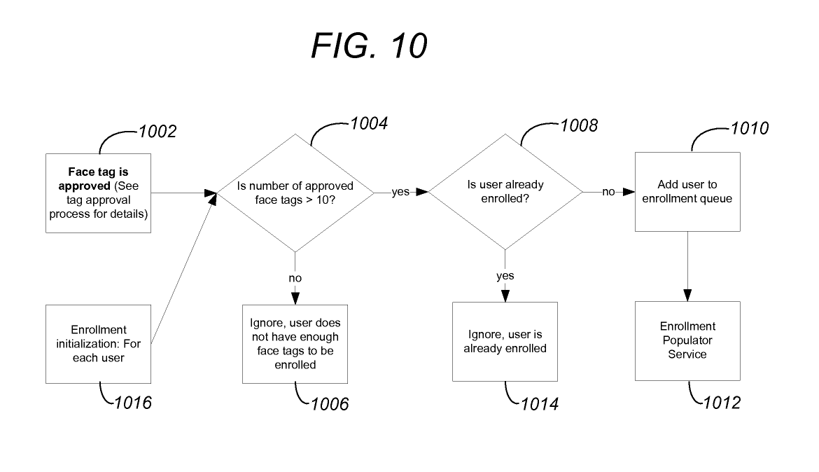

Based on the tag approval process described above, various portions of the enrollment process may rely on such tag approvals. FIG. 10 is a flow chart illustrating the image auto tagging enrollment process based on the tag approval process in accordance with one or more embodiments of the invention.

The enrollment process works only with face tags that have been approved by the person whose face was tagged (i.e., at step 1002) and works two ways.

In the first way, each time a new face tag is accepted a check is conducted to see how many approved face tags there are for the user. At step 1004, a determination is made regarding whether the user has at least ten (10) approved face tags.

If there are less that ten (10) approved face tags, the new face tag is ignored at step 1006 as the user is not yet eligible for image auto tagging enrollment, as more approved face tags are needed to ensure quality images.

If there are ten or more approved face tags, the process checks to determine if the user is already enrolled in image auto tagging at step 1008. If not already enrolled, the user is enrolled at step 1010. To enroll users, the process adds the user to an enrollment queue and uses an enrollment populator service at step 1012. The enrollment populator service constantly polls the queue for new users to enroll in the image auto tagging, and processes the user as described above.

If the user is not already enrolled in image auto tagging (i.e., as determined at step 1008), nothing needs to be done as the user is already enrolled at step 1014.

In the second way, at step 1016, image auto tagging enrollment may be used for existing users to initialize the image auto tagging system by adding users to the enrollment queue if they already have at least ten (10) approved face tags and are not already enrolled. The enrollment populator service 1012 (e.g., described above with respect to FIG. 5) then takes over to process the users.

The enrollment process ensures that only eligible users are submitted to the image auto tagging for FIR creation. Eligibility is determined by the number of approved face tags, which is the minimum need to generate a quality FIR. This process also solves a crash recovery issue whereby if the FIR generation process fails, the process will be able to restart without any loss. Without this, a failure would result in some eligible users not having a FIR created.

Accordingly, the enrollment process prevents the use of unapproved face tags from using the system outlined in the tag approval process. In addition, a threshold may be established for the minimum number of face tags that must be found through manual tagging or through automatic tagging prior to enrollment. The enrollment process may also be provided with the people and face tags required for FIR generation. Further, fault tolerance may be established wherein new face tags are retained in a queue until the enrollment service confirms that they have been successfully processed.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

Advantages/benefits of the invention include that the subject does not need to be in a controlled setting in order to generate a “good” FIR. Further, embodiments of the invention provide for high throughput and increased facial recognition accuracy. In addition, prior manual tags are used to generate an FIR. Also, the process for enrollment and identification of tags and users is fully automated.

As an improvement on the above described process, existing FIRs may be improved based on user feedback choices. The system may also automatically capture user selection with a backend process for continually updating FIRs. Virality may be improved by getting other users to generate tags for themselves, so that FIRs can be created for them.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for automatically tagging a photograph in a computer system, comprising:
(a) obtaining one or more first photographs, wherein:
(i) each of the one or more first photographs is associated with a tag; and
(ii) the tag uniquely identifies one of one or more users;
(b) based on the tag and the one or more first photographs, generating a single facial identification record (FIR) for the one of the one or more users;
(c) obtaining a newly uploaded second photograph from an uploading user that is one of the one or more users;
(d) obtaining one or more profile based FIRs based on the uploading user, wherein one of the one or more profile based FIRs comprises the single FIR; and
(e) obtaining a matching FIR from the one or more profile based FIRs that matches a second face in the second photograph.

2. The computer-implemented method of claim 1, wherein the generating the single FIR comprises:
generating a cropped image for each tag;
for each cropped image, determining a level of confidence that a first face has been found in each cropped image; and
using all of the cropped images having a level of confidence that exceeds a confidence threshold, generating the single FIR representative of the first face.

3. The computer-implemented method of claim 2, wherein the generating of the single FIR representative of the first face comprises:
dividing the cropped images having a level of confidence exceeding the confidence threshold into one or more groups having a first predefined number;
for each of the one or more groups, generating a single group FIR representative of the first face appearing in each cropped image in each group;
comparing the single group FIRs from each of the one or more groups to a second predefined number of the one or more first photographs to determine which of the single group FIRs has a maximum match score; and
selecting the single group FIR with the maximum match score as the single FIR for the one of the one or more users.

4. The computer-implemented method of claim 1, wherein the generating the single FIR is performed using an enrollment service and a facial recognition service that is wrapped in a windows communication foundation (WCF) application programming interface (API).

5. The computer-implemented method of claim 4, wherein the enrollment service is configured to perform the steps of:
preventing a user of unapproved tags from generating an FIR; and
providing a threshold for a minimum number of tags before generating an FIR.

6. The computer-implemented method of claim 4, wherein the enrollment service is configured to perform the steps of:
retaining new tags in a queue until the enrollment service confirms that the new tags have been successfully processed.

7. The computer-implemented method of claim 1, wherein the matching FIR is obtained using facial recognition software that is configured to:
identify the second face in the second photograph; and
match the second face to one of the profile based FIRs.

8. The computer-implemented method of claim 1, wherein the obtaining the matching FIR comprises obtaining a match score indicating a likelihood that the matching FIR matches the second face.

9. The computer-implemented method of claim 1, wherein the steps of obtaining the one or more profile based FIRs and obtaining the matching FIR from the one or more profile based FIRs are managed by a work distribution server that assigns processing to one or more drone recognition servers.

10. The computer-implemented method of claim 1, wherein a quality of the single FIR is enhanced by obtaining approval of a person whose face was tagged by requiring the person to manually approval the tag.

11. The computer-implemented method of claim 1, wherein a quality of the single FIR is enhanced by obtaining approval of a person whose face was tagged by automatically approving the tag.

12. The computer-implemented method of claim 1, wherein a quality of the single FIR is enhanced by obtaining approval of a person whose face was tagged by requiring an owner of one of the one or more first photographs to approve creation of the tag in the one or more first photographs.

13. The computer-implemented method of claim 1, wherein a quality of the single FIR is enhanced by requiring approval of the tag prior to using it to generate the FIR.

14. A system for automatically tagging a photograph in a computer system comprising:
(a) a computer having a memory;
(b) one or more first photographs, wherein:
(1) each of the one or more first photographs is associated with a tag; and
(2) the tag uniquely identifies one of one or more users;
(c) an application executing on the computer, wherein the application is configured to:
(i) obtain the one or more first photographs,
(ii) based on the tag and the one or more first photographs, generate a single facial identification record (FIR) for the one of the one or more users;
(iii) obtain a newly uploaded second photograph from an uploading user that is one of the one or more users;
(iv) obtain one or more profile based FIRs based on the uploading user, wherein one of the one or more profile based FIRs comprises the single FIR; and
(v) obtain a matching FIR from the one or more profile based FIRs that matches a second face in the second photograph.

15. The system of claim 14, wherein the application is configured to generate the single FIR by:
generating a cropped image for each tag;
for each cropped image, determining a level of confidence that a first face has been found in each cropped image; and
using all of the cropped images having a level of confidence that exceeds a confidence threshold, generating the single FIR representative of the first face.

16. The system of claim 15, wherein the application is configured to generate the single FIR representative of the first face by:
dividing the cropped images having a level of confidence exceeding the confidence threshold into one or more groups having a first predefined number;
for each of the one or more groups, generating a single group FIR representative of the first face appearing in each cropped image in each group;
comparing the single group FIRs from each of the one or more groups to a second predefined number of the one or more first photographs to determine which of the single group FIRs has a maximum match score; and
selecting the single group FIR with the maximum match score as the single FIR for the one of the one or more users.

17. The system of claim 14, wherein the application is configured to generate the single FIR using an enrollment service and a facial recognition service that is wrapped in a windows communication foundation (WCF) application programming interface (API).

18. The system of claim 17, wherein the enrollment service is configured to perform the steps of:
preventing a user of unapproved tags from generating an FIR; and
providing a threshold for a minimum number of tags before generating an FIR.

19. The system of claim 17, wherein the enrollment service is configured to perform the steps of:
retaining new tags in a queue until the enrollment service confirms that the new tags have been successfully processed.

20. The system of claim 14, wherein the matching FIR is obtained using facial recognition software that is configured to:
identify the second face in the second photograph; and
match the second face to one of the profile based FIRs.

21. The system of claim 14, wherein the application is configured to obtain the matching FIR by obtaining a match score indicating a likelihood that the matching FIR matches the second face.

22. The system of claim 14, wherein the application further comprises a work distribution server that is configured to obtain the one or more profile based FIRs and obtain the matching FIR from the one or more profile based FIRs by managing work load by assigning processing to one or more drone recognition servers.

23. The system of claim 14, wherein a quality of the single FIR is enhanced by obtaining approval of a person whose face was tagged by requiring the person to manually approval the tag.

24. The system of claim 14, wherein a quality of the single FIR is enhanced by obtaining approval of a person whose face was tagged by automatically approving the tag.

25. The system of claim 14, wherein a quality of the single FIR is enhanced by obtaining approval of a person whose face was tagged by requiring an owner of one of the one or more first photographs to approve creation of the tag in the one or more first photographs.

26. The system of claim 14, wherein a quality of the single FIR is enhanced by requiring approval of the tag prior to using it to generate the FIR.

27. A computer readable storage medium encoded with computer program instructions which when accessed by a computer cause the computer to load the program instructions to a memory therein creating a special purpose data structure causing the computer to operate as a specially programmed computer, executing a method of automatically tagging a photograph, comprising:
(a) obtaining, in the specially programmed computer, one or more first photographs, wherein:
(i) each of the one or more first photographs is associated with a tag; and
(ii) the tag uniquely identifies one of one or more users;
(b) based on the tag and the one or more first photographs, generating, in the specially programmed computer, a single facial identification record (FIR) for the one of the one or more users;
(c) obtaining, in the specially programmed computer, a newly uploaded second photograph from an uploading user that is one of the one or more users;
(d) obtaining, in the specially programmed computer, one or more profile based FIRs based on the uploading user, wherein one of the one or more profile based FIRs comprises the single FIR; and
(e) obtaining, in the specially programmed computer, a matching FIR from the one or more profile based FIRs that matches a second face in the second photograph.

28. The computer readable storage medium of claim 27, wherein the generating the single FIR comprises:
generating, in the specially programmed computer, a cropped image for each tag;
for each cropped image, determining, in the specially programmed computer, a level of confidence that a first face has been found in each cropped image; and
using all of the cropped images having a level of confidence that exceeds a confidence threshold, generating, in the specially programmed computer, the single FIR representative of the first face.

29. The computer readable storage medium of claim 28, wherein the generating of the single FIR representative of the first face comprises:
dividing, in the specially programmed computer, the cropped images having a level of confidence exceeding the confidence threshold into one or more groups having a first predefined number;
for each of the one or more groups, generating, in the specially programmed computer, a single group FIR representative of the first face appearing in each cropped image in each group;
comparing, in the specially programmed computer, the single group FIRs from each of the one or more groups to a second predefined number of the one or more first photographs to determine which of the single group FIRs has a maximum match score; and
selecting, in the specially programmed computer, the single group FIR with the maximum match score as the single FIR for the one of the one or more users.

30. The computer readable storage medium of claim 27, wherein the generating the single FIR is performed using an enrollment service and a facial recognition service that is wrapped in a windows communication foundation (WCF) application programming interface (API).

31. The computer readable storage medium of claim 30, wherein the enrollment service is configured to perform the steps of:
preventing a user of unapproved tags from generating an FIR; and
providing a threshold for a minimum number of tags before generating an FIR.

32. The computer readable storage medium of claim 30, wherein the enrollment service is configured to perform the steps of:
retaining new tags in a queue until the enrollment service confirms that the new tags have been successfully processed.

33. The computer readable storage medium of claim 27, wherein the matching FIR is obtained using facial recognition software that is configured to:
identify the second face in the second photograph; and
match the second face to one of the profile based FIRs.

34. The computer readable storage medium of claim 27, wherein the obtaining the matching FIR comprises obtaining a match score indicating a likelihood that the matching FIR matches the second face.

35. The computer readable storage medium of claim 27, wherein the steps of obtaining the one or more profile based FIRs and obtaining the matching FIR from the one or more profile based FIRs are managed by a work distribution server that assigns processing to one or more drone recognition servers.

36. The computer readable storage medium of claim 27, wherein a quality of the single FIR is enhanced by obtaining approval of a person whose face was tagged by requiring the person to manually approval the tag.

37. The computer readable storage medium of claim 27, wherein a quality of the single FIR is enhanced by obtaining approval of a person whose face was tagged by automatically approving the tag.

38. The computer readable storage medium of claim 27, wherein a quality of the single FIR is enhanced by obtaining approval of a person whose face was tagged by requiring an owner of one of the one or more first photographs to approve creation of the tag in the one or more first photographs.

39. The computer readable storage medium of claim 27, wherein a quality of the single FIR is enhanced by requiring approval of the tag prior to using it to generate the FIR.
